(19) United States
(12) Patent Application Publication
(10) Pub. No.: US 2010/0239032 A1
(43) Pub. Date: Sep. 23, 2010

(54) SYSTEM AND METHOD FOR PRECODING AND DATA EXCHANGE IN WIRELESS COMMUNICATION

(75) Inventors: Ren-Jr CHEN, Hsinchu City (TW); Chia-Wen HSIEH, Chiayi City (TW); Chang-Lung HSIAO, Taipei City (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Industrial Technology Research Institute

(21) Appl. No.: 12/539,779

(22) Filed: Aug. 12, 2009

Related U.S. Application Data
(60) Provisional application No. 61/161,893, filed on Mar. 20, 2009.

(51) Int. Cl. H04K 1/10

(52) U.S. Cl. 375/260

(57) ABSTRACT

A method for a first user terminal to receive data from a second user terminal, wherein the first and second user terminals communicate with a transmitting terminal. The method includes: transmitting a first message to the transmitting terminal; receiving a signal from the transmitting terminal, the received signal including information regarding the first message and a second message transmitted from the second user terminal to the transmitting terminal; and decoding, based on the first message, the received signal to receive the second message.

### RELATED APPLICATIONS

This application is based upon and claims the benefit of priority from U.S. Provisional Patent Application No. 61/161,893, filed Mar. 20, 2009, the entire contents of which are incorporated herein by reference.

### TECHNICAL FIELD

This disclosure relates to systems and methods for a first user terminal to receive data from a second user terminal in a wireless communication system.

### BACKGROUND

Multiple-input and multiple-output (MIMO) techniques, which use multiple antennas on a transmitter side and/or a receiver side of a communication system to improve communication performance, have gained worldwide popularity due to their broad applications. MIMO techniques have been included in wireless communication standards, such as IEEE standards 802.11 and 802.16.

In a wireless communication system based on a multiple-user MIMO (MU-MIMO) technique, a transmitting terminal, e.g., a base station, may communicate with multiple user terminals simultaneously. The MU-MIMO technique may increase channel sum capacity for the communication system, because, theoretically, the channel sum capacity grows linearly with a minimum number of user terminals and a number of antennas of the transmitting terminal.

Conventionally, the MU-MIMO technique has been implemented with such methods as channel inversion, network coding, and vector perturbation. Each of these methods is known in the art and will not be discussed further.

### SUMMARY

According to an exemplary embodiment, there is provided a method for a first user terminal to receive data from a second user terminal, wherein the first and second user terminals communicate with a transmitting terminal, the method comprising: transmitting a first message to the transmitting terminal; receiving a signal from the transmitting terminal, the received signal including information regarding the first message and a second message transmitted from the second user terminal to the transmitting terminal; and decoding, based on the first message, the received signal to receive the second message.

According to an exemplary embodiment, there is provided a first user terminal to receive data from a second user terminal, wherein the first and second user terminals communicate with a transmitting terminal, the first user terminal comprising: at least one antenna configured to transmit a first message to the transmitting terminal and to receive a signal from the transmitting terminal, the received signal including information regarding the first message and a second message transmitted from the second user terminal to the transmitting terminal; and a processor configured to decode, based on the first message, the received signal to receive the second message.

According to an exemplary embodiment, there is provided a method for a transmitting terminal to transmit precoded signals, comprising: receiving first and second messages from first and second user terminals, respectively, thereby to determine the first and second user terminals are exchanging data; performing, based on the determining that the first and second user terminals are exchanging data, precoding on the first and second messages to generate precoded signals; and transmitting the precoded signals.

According to an exemplary embodiment, there is provided a transmitting terminal, comprising: a plurality of antennas configured to receive first and second messages from first and second user terminals, respectively; a processor configured to perform, based on determining the first and second user terminals are exchanging data, preceding on the first and second messages to generate precoded signals; and the plurality of antennas configured to transmit the precoded signals.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate exemplary embodiments and, together with the description, serve to explain the principles of the exemplary embodiments.

FIG. 1 illustrates a block diagram of a wireless communication system, according to an exemplary embodiment.

FIGS. 2A and 2B illustrate a method for a first user terminal and a second user terminal in a MU-MIMO system to exchange data through communication with a transmitting terminal, according to an exemplary embodiment.

FIGS. 3A and 3B illustrate a method for a first user terminal and a second user terminal in a MU-MIMO system to exchange data through communication with a transmitting terminal, according to an exemplary embodiment.

FIGS. 4A-4D illustrate a method for a first user terminal, a second user terminal, and a third user terminal in a MU-MIMO system to exchange data through communication with a transmitting terminal, according to an exemplary embodiment.

FIGS. 5A and 5B illustrate a method for a first user terminal, a second user terminal, and a third user terminal in a MU-MIMO system to exchange data through communication with a transmitting terminal, according to an exemplary embodiment.

FIGS. 6A and 6B illustrate a method for first and second user terminals in a MU-MIMO system to exchange data through communication with a relay station, according to an exemplary embodiment.

FIGS. 7A and 7B illustrate a method for a first user terminal and a second user terminal in a MU-MIMO system to exchange data through communication with a relay station and a base station, according to an exemplary embodiment.

FIGS. 8A and 8B illustrate a method for first and second user terminals in a MU-MIMO system to exchange data through communication with first and second base stations, according to an exemplary embodiment.

FIG. 9 illustrates a MU-MIMO system, according to an exemplary embodiment.

FIG. 10 illustrates a method for a transmitting terminal to generate precoded signals and modulate the precoded signals based on an OFDM technique, according to an exemplary embodiment.

FIG. 11 illustrates a block diagram of a transmitting terminal, according to an exemplary embodiment.

FIG. 12 illustrates a block diagram of a user terminal, according to an exemplary embodiment.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention as recited in the appended claims.

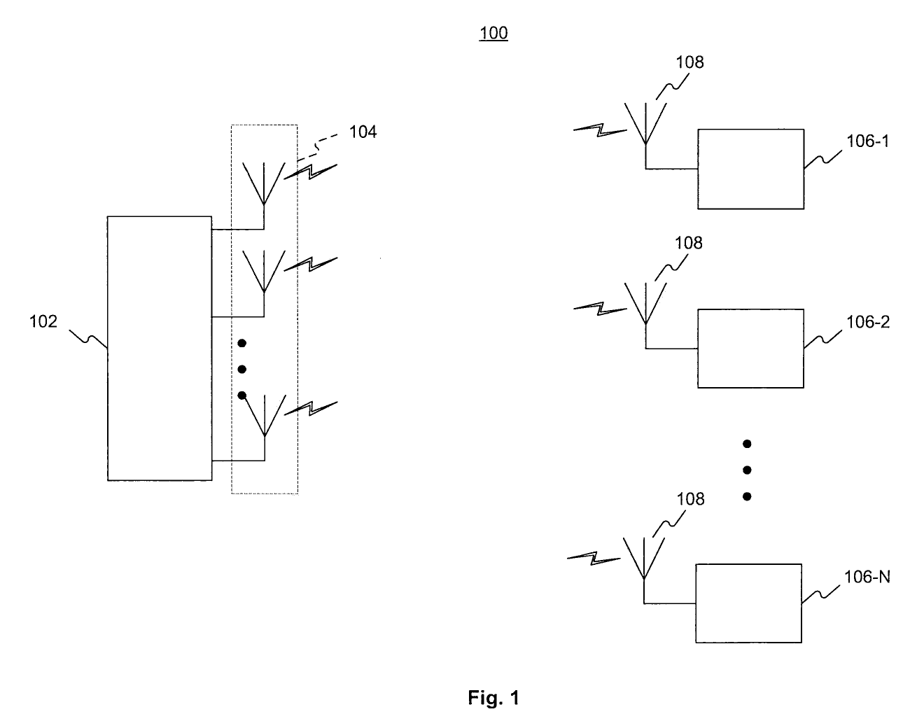

FIG. 1 illustrates a block diagram of a wireless communication system 100, according to an exemplary embodiment. The system 100 includes a transmitting terminal 102 having a plurality of antennas 104, and a plurality of user terminals 106-1, 106-2, . . . , and 106-N (N is the total number of user terminals in the system 100) each having at least one antenna 108. For example, the transmitting terminal 102 may be a base station, a relay station, or an access point, and each of the user terminals 106-1, 106-2, . . . , and 106-N may be a mobile station or a fixed station.

In exemplary embodiments, the system 100 is configured to operate based on a multiple-user multiple-input and multiple-output (MU-MIMO) technique, and is therefore also referred to as a MU-MIMO system. Based on the MU-MIMO technique, the transmitting terminal 102 is configured to simultaneously, or at substantially the same time, transmit data to the user terminals 106-1, 106-2, . . . , and 106-N. As a result, channel sum capacity of the system 100 may be increased.

In exemplary embodiments, ones of the user terminals 106-1, 106-2, . . . , and 106-N may exchange data, e.g., messages, with each other through communication with the transmitting terminal 102. For example, the user terminal 106-1 may intend to send a first message to the user terminal 106-2, and the user terminal 106-2 may intend to send a second message to the user terminal 106-1. Accordingly, the user terminal 106-1 and the user terminal 106-2 transmit the first message and the second message, respectively, to the transmitting terminal 102. After receiving the first and second messages, the transmitting terminal 102 determines the user terminals 106-1 and 106-2 are exchanging data. The transmitting terminal 102 further performs preceding based on determining the user terminals 106-1 and 106-2 are exchanging data, as described below, on the first and second messages to generate precoded signals, and simultaneously transmits the precoded signals to the user terminals 106-1 and 106-2.

As a result, the user terminal 106-1 may receive the precoded signals and decode the received signals to receive the second message from the user terminal 106-2, based on the first message sent by, and therefore known to, the user terminal 106-1, as described below. Similarly, the user terminal 106-2 may receive the precoded signals and decode the received signals to receive the first message from the user terminal 106-1, based on the second message sent by, and therefore known to, the user terminal 106-2, also as described below. In such manner, the user terminals 106-1 and 106-2 may exchange data with each other.

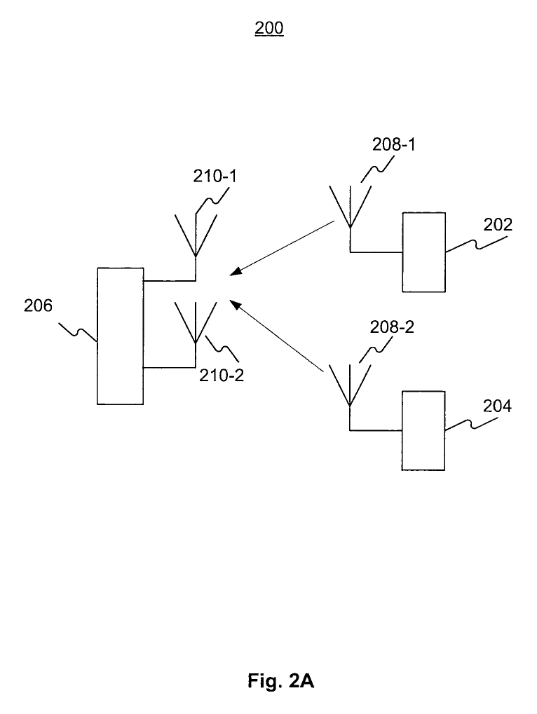

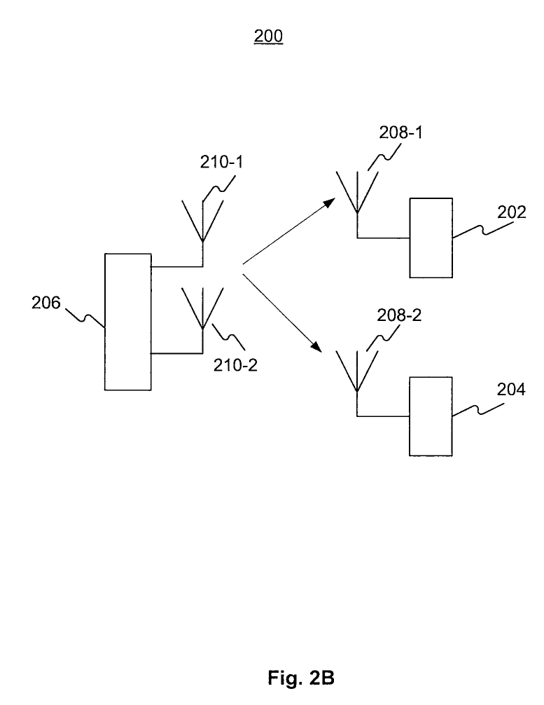

FIGS. 2A and 2B illustrate a method 200 for a first user terminal 202 and a second user terminal 204 in a MU-MIMO system to exchange data through communication with a transmitting terminal 206, according to an exemplary embodiment. For example, the user terminals 202 and 204 may be any two of the user terminals 106-1, 106-2, . . . , and 106-N (FIG. 1), such as the user terminals 106-1 and 106-2, respectively, and the transmitting terminal 206 may be the transmitting terminal 102 (FIG. 1). Also for example, the data to be exchanged may be a first message u₁ from the first user terminal 202 and a second message u₂ from the second user terminal 204. For illustrative purposes only, it is assumed that the first user terminal 202 includes an antenna 208-1, and the second user terminal 204 includes an antenna 208-2. It is also assumed that the transmitting terminal 206 includes a first antenna 210-1 and a second antenna 210-2.

Referring to FIG. 2A, during a first time slot T₁, the first user terminal 202 and the second user terminal 204 transmit the first message u₁ and the second message u₂, respectively, to the transmitting terminal 206, as represented by the arrows in FIG. 2A. In the illustrated embodiment and the embodiments below, an arrow is used to represent communications between a transmitting terminal and a user terminal, or communications between transmitting terminals. As a result, the transmitting terminal 206 receives the first message u₁ and the second message u₂ during the first time slot T₁.

Referring to FIG. 2B, during a second time slot T₂ following the first time slot T₁, the transmitting terminal 206 performs preceding on the first and second messages u₁ and u₂ based on channel state information, e.g., channel responses of communication channels between the transmitting terminal 206 and each of the first and second user terminals 202 and 204.

In exemplary embodiments, the first and second user terminals 202 and 204 may estimate the channel state information, e.g., the channel responses of the communication channels, based on pilot or reference signals received from the transmitting terminal 206, and provide feedback of the channel state information to the transmitting terminal 206. As a result, the transmitting terminal 206 obtains the channel state information based on the provided feedback. Alternatively, the first and second user terminals 202 and 204 may each transmit pilot or reference signals to the transmitting terminal 206, for the transmitting terminal 206 to estimate the channel state information.

More particularly, a communication channel is established between each of the antennas 208-1 and 208-2 on the user terminal side and each of the antennas 210-1 and 210-2 on the transmitting terminal side. The communication channel between an i^{th} one of the antennas 208-1 and 208-2 on the user terminal side and a j^{th} one of the antennas 210-1 and 210-2 on the transmitting terminal side has a channel response hᵢⱼ (i=1 or 2; j=1 or 2). For example, the communication channel between the antenna 208-1 of the first user terminal 202 and the antenna 210-1 of the transmitting terminal 206 has the channel response h₁₁. Also, for example, the communication channel between the antenna 208-2 of the second user terminal 204 and the antenna 210-1 of the transmitting terminal 206 has the channel response h₂₁. Typically, the channel response hᵢⱼ is a complex number having a magnitude and a phase.

In exemplary embodiments, a vector x may be used to represent the first message u₁ and the second message u₂ received by the transmitting terminal 206, as follows:

$$x = [ \begin{matrix}{u}_{1} \\ {u}_{2}\end{matrix} ] . \qquad equation ( 1 )$$

Accordingly, the preceding performed by the transmitting terminal 206 on the first message u₁ and the second message u₂ may be expressed as follows:

$${x}^{′} = Px = [ \begin{matrix}{P}_{11} & {P}_{12} \\ {P}_{21} & {P}_{22}\end{matrix} ] [ \begin{matrix}{u}_{1} \\ {u}_{2}\end{matrix} ] = [ \begin{matrix}{x}_{1}^{′} \\ {x}_{2}^{′}\end{matrix} ] , \qquad equation ( 2 )$$

where P is a precoding matrix including elements P₁₁, P₁₂, P₂₁, and P₂₂ determined based on methods described below, and x′ is a vector representing a set of precoded signals x₁′ and X₂′ to be transmitted on the antennas 210-1 and 210-2, respectively.

In exemplary embodiments, the transmitting terminal 206 simultaneously transmits, after modulation, the precoded signals x₁′ and x₂′ to each of the first and second user terminals 202 and 204, as represented by the arrows in FIG. 2B. As a result, signals received by the first and second user terminals 202 and 204 may be calculated as follows:

y=Hx′+w, equation (3)

where y is a vector representing signals y₁ and y₂ received at the first and second user terminals 202 and 204, respectively, i.e.,

$$y = [ \begin{matrix}{y}_{1} \\ {y}_{2}\end{matrix} ] ; \qquad equation ( 4 )$$

H is a channel response matrix representing the channel responses of the communication channels, and is expressed as follows:

$$H = [ \begin{matrix}{h}_{11} & {h}_{12} \\ {h}_{21} & {h}_{22}\end{matrix} ] ; \qquad equation ( 5 )$$

and w is a vector representing noise signals w₁ and w₂ received at the first and second user terminals 202 and 204, respectively, i.e.,

$$w = [ \begin{matrix}{w}_{1} \\ {w}_{2}\end{matrix} ] . \qquad equation ( 6 )$$

Based on equations (2)-(6), the signals y₁ and y₂ respectively received at the user terminals 202 and 204 may be expressed as follows:

$$[ \begin{matrix}{y}_{1} \\ {y}_{2}\end{matrix} ] = [ \begin{matrix}{h}_{11} & {h}_{12} \\ {h}_{21} & {h}_{22}\end{matrix} ] [ \begin{matrix}{P}_{11} & {P}_{12} \\ {P}_{21} & {P}_{22}\end{matrix} ] [ \begin{matrix}{u}_{1} \\ {u}_{2}\end{matrix} ] + [ \begin{matrix}{w}_{1} \\ {w}_{2}\end{matrix} ] . \qquad equation ( 7 )$$

In other words,

y₁=(h₁₁P₁₁+h₁₂P₂₁)u₁+(h₁₁P₁₂+h₁₂P₂₂)u₂w₁

y₂(h₂₁P₁₁+h₂₂P₂₁)u₁+(h₂₁P₁₂+h₂₂P₂₂)u₂+w₂. equations (8)

The first user terminal 202 further decodes the received signal y₁ to receive the message u₂ from the second user terminal 204. Therefore, it would be beneficial to maximize the component in the signal y₁ that corresponds to the second message u₂, i.e., the term (h₁₁P₁₂+h₁₂P₂₂)u₂ in equations (8). Similarly, the second user terminal 204 further decodes the received signal y₂ to receive the message u₁ from the first user terminal 202. Therefore, it would be beneficial to maximize the component in the signal y₂ that corresponds to the first message u₁, i.e., the term (h₂₁P₁₁+h₂₂P₂₁)u₁ in equations (8).

Therefore, in exemplary embodiments, the precoding matrix P is determined as follows:

$$P = [ \begin{matrix}{P}_{11} & {P}_{12} \\ {P}_{21} & {P}_{22}\end{matrix} ] = [ \begin{matrix}{h}_{21}^{*} & {h}_{11}^{*} \\ {h}_{22}^{*} & {h}_{12}^{*}\end{matrix} ] , \qquad equation ( 9 )$$

where “*” denotes a conjugate of a complex number. When the precoding matrix P is so determined, the term (h₁₁P₁₂+h₁₂P₂₂)u₂ in the signal y₁ and the term (h₂₁P₁₁+h₂₂P₂₁)u₁ in the signal y₂, as shown in equations (8), may each be maximized.

Accordingly, the precoded signals x₁′ and x₂′ in equation (2) may be expressed as follows:

$${x}^{′} = Px = [ \begin{matrix}{h}_{21}^{*} & {h}_{11}^{*} \\ {h}_{22}^{*} & {h}_{12}^{*}\end{matrix} ] [ \begin{matrix}{u}_{1} \\ {u}_{2}\end{matrix} ] = [ \begin{matrix}{x}_{1}^{′} \\ {x}_{2}^{′}\end{matrix} ] , \qquad equation ( 10 )$$

and the received signals y₁ and y₂ in equations (8) may expressed as follows:

y₁=(h₁₁h₂₁*+h₁₂h₂₂*)u₁+(h₁₁h₁₁*+h₁₂h₁₂*)u₂+w₁

y₂=(h₂₁h₂₁*+h₂₂h₂₂*)u₁+(h₂₁h₁₁*+h₂₂h₁₂*)u₂+w₂.

equations (11)

Equations (11) can be written more compactly by defining \tilde{h}₁₁=h₁₁h₂₁*+h₁₂h₂₂*, \tilde{h}₁₂=h₁₁h₁₁*+h₁₂h₁₂*, \tilde{h}₁₃=h₂₁h₂₁*+h₂₂h₂₂*, and \tilde{h}₁₄=h₂₁h₁₁^{*}+h₂₂h₁₂*, where \tilde{h}₁₁, \tilde{h}₁₂, \tilde{h}₂₁, and \tilde{h}₂₂ are equivalent channel gains. Accordingly, the signals y₁ and y₂ may be further expressed as follows:

y₁=\tilde{h}₁₁u₁+\tilde{h}₁₂u₂+w₁

y₂=\tilde{h}₂₁u₁+\tilde{h}₂₂u₂+w₂ equations (12)

As described above, the user terminals 202 and 204 may estimate the channel responses of the communication channels and, hence, can calculate the equivalent channel gains. Furthermore, the first and second messages u₁ and u₂ are known to the first and second user terminals 202 and 204, respectively, since the first and second user terminals 202 and 204 transmitted the first and second messages u₁ and u₂ to the transmitting terminal 206, respectively. Therefore, the first user terminal 202 may subtract the signal component corresponding to the term \tilde{h}₁₁u₁ in equations (12) from the received signal y₁ and, similarly, the second user terminal 204 may subtract the signal component corresponding to the term \tilde{h}₂₂u₂ in equations (12) from the received signal y₂.

Additionally, the first and second user terminals 202 and 204 may also operate to remove the noise signals w₁ and w₂, respectively, from their received signals y₁ and y₂. In such manner, the first user terminal 202 may decode, on a bit level or a symbol level, the received signal y₁ to receive the second message u₂ from the second user terminal 204 with the equivalent channel gain \tilde{h}₁₂ being maximized, and the second user terminal 204 may decode, on a bit level or a symbol level, the received signal y₂ to receive the first message u₁ from the first user terminal 202 with the equivalent channel gain \tilde{h}₂₁ being maximized. As a result, the first user terminal 202 and the second user terminal 204 exchange data with each other.

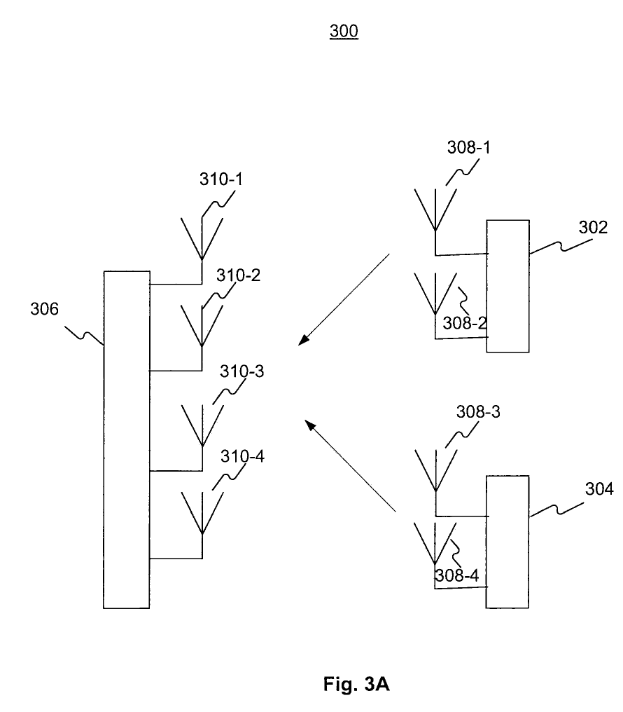

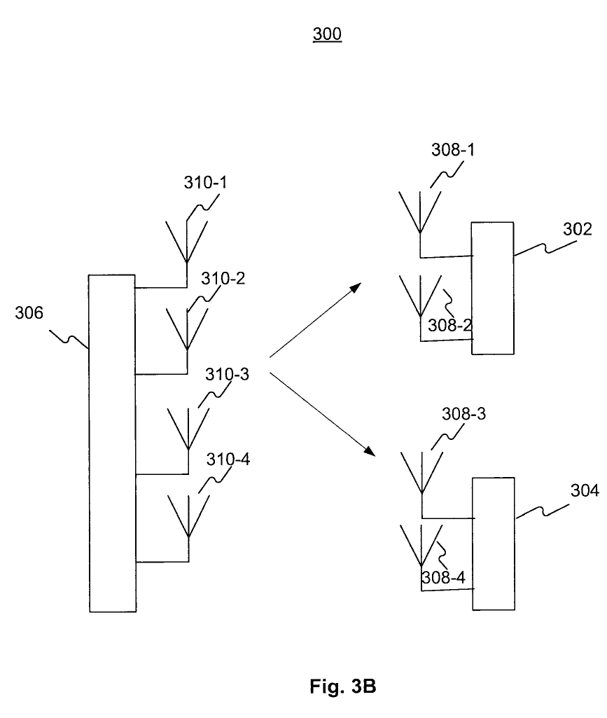

FIGS. 3A and 3B illustrate a method 300 for a first user terminal 302 and a second user terminal 304 in a MU-MIMO system to exchange data through communication with a transmitting terminal 306, according to an exemplary embodiment. For example, the user terminals 302 and 304 may be any two of the user terminals 106-1, 106-2, . . . , and 106-N (FIG. 1), such as the user terminals 106-1 and 106-2, respectively, and the transmitting terminal 306 may be the transmitting terminal 102 (FIG. 1). Also for example, the data to be exchanged may be a first message u₁ and a second message u₂ from the first user terminal 302, and a third message u₃ and a fourth message u₄ from the second user terminal 304. For illustrative purposes only, it is assumed that the first user terminal 302 includes a first antenna 308-1 and a second antenna 308-2, and the second user terminal 304 includes a first antenna 308-3 and a second antenna 308-4. It is also assumed that the transmitting terminal 306 includes a first antenna 310-1, a second antenna 310-2, a third antenna 310-3, and a fourth antenna 310-4.

Referring to FIG. 3A, during a first time slot T₁, the first user terminal 302 transmits the first and second messages u₁ and u₂ to the transmitting terminal 306, and the second user terminal 304 transmits the third and fourth messages u₃ and u₄ to the transmitting terminal 306, as represented by the arrows in FIG. 3A. As a result, the transmitting terminal 306 receives the messages u₁, u₂, u₃, and u₄ during the first time slot T₁.

Referring to FIG. 3B, during a second time slot T₂ following the first time slot T₁, the transmitting terminal 306 performs precoding on the messages u₁, u₂, u₃, and u₄, based on channel state information, e.g., channel responses of communication channels, between the transmitting terminal 306 and each of the first and second user terminals 302 and 304.

More particularly, a communication channel is established between each of the antennas 308-1, 308-2, 308-3, and 308-4 on the user terminal side and each of the antennas 310-1, 310-2, 310-3, and 310-4 on the transmitting terminal side. The communication channel between an i^{th} one of the antennas 308-1, 308-2, 308-3, and 308-4 on the user terminal side and a j^{th} one of the antennas 310-1, 310-2, 310-3, and 310-4 on the transmitting terminal side has a channel response hᵢⱼ(i=1, 2, 3, or 4; j=1, 2, 3, or 4). For example, the communication channel between the antenna 308-1 of the first user terminal 302 and the antenna 310-1 of the transmitting terminal 306 has the channel response h₁₁. Also, for example, the communication channel between the antenna 308-4 of the second user terminal 304 and the antenna 310-1 of the transmitting terminal 306 has the channel response h₄₁.

Similar to the above description, a preceding matrix P may be determined by the transmitting terminal 306 as follows:

$$P = [ \begin{matrix}{h}_{31}^{*} & {h}_{41}^{*} & {h}_{11}^{*} & {h}_{21}^{*} \\ {h}_{32}^{*} & {h}_{42}^{*} & {h}_{12}^{*} & {h}_{22}^{*} \\ {h}_{33}^{*} & {h}_{43}^{*} & {h}_{13}^{*} & {h}_{23}^{*} \\ {h}_{34}^{*} & {h}_{44}^{*} & {h}_{14}^{*} & {h}_{24}^{*}\end{matrix} ] . \qquad equation ( 13 )$$

The transmitting terminal 306 may perform preceding on the messages u₁, u₂, u₃, and u₄, and generate a set of precoded signals x₁′, x₂′, x₃′, and x₄′ to be transmitted on the antennas 310-1, 310-2, 310-3, and 310-4, respectively, as follows:

$$[ \begin{matrix}{x}_{1}^{′} \\ {x}_{2}^{′} \\ {x}_{3}^{′} \\ {x}_{4}^{′}\end{matrix} ] = [ \begin{matrix}{h}_{31}^{*} & {h}_{41}^{*} & {h}_{11}^{*} & {h}_{21}^{*} \\ {h}_{32}^{*} & {h}_{42}^{*} & {h}_{12}^{*} & {h}_{22}^{*} \\ {h}_{33}^{*} & {h}_{43}^{*} & {h}_{13}^{*} & {h}_{23}^{*} \\ {h}_{34}^{*} & {h}_{44}^{*} & {h}_{14}^{*} & {h}_{24}^{*}\end{matrix} ] [ \begin{matrix}{u}_{1} \\ {u}_{2} \\ {u}_{3} \\ {u}_{4}\end{matrix} ] . \qquad equation ( 14 )$$

In exemplary embodiments, the transmitting terminal 306 simultaneously transmits, after modulation, the precoded signals x₁′, x₂′, x₃′, and x₄′ to each of the first and second user terminals 302 and 304, as represented by the arrows in FIG. 3B. As a result, signals received at the first and second user terminals 302 and 304 may be determined as follows:

$$[ \begin{matrix}{y}_{1} \\ {y}_{2} \\ {y}_{3} \\ {y}_{4}\end{matrix} ] = [ \begin{matrix}{h}_{11} & {h}_{12} & {h}_{13} & {h}_{14} \\ {h}_{21} & {h}_{22} & {h}_{23} & {h}_{24} \\ {h}_{31} & {h}_{32} & {h}_{33} & {h}_{34} \\ {h}_{41} & {h}_{42} & {h}_{43} & {h}_{44}\end{matrix} ] [ \begin{matrix}{h}_{31}^{*} & {h}_{41}^{*} & {h}_{11}^{*} & {h}_{21}^{*} \\ {h}_{32}^{*} & {h}_{42}^{*} & {h}_{12}^{*} & {h}_{22}^{*} \\ {h}_{33}^{*} & {h}_{43}^{*} & {h}_{13}^{*} & {h}_{23}^{*} \\ {h}_{34}^{*} & {h}_{44}^{*} & {h}_{14}^{*} & {h}_{24}^{*}\end{matrix} ] [ \begin{matrix}{u}_{1} \\ {u}_{2} \\ {u}_{3} \\ {u}_{4}\end{matrix} ] + [ \begin{matrix}{w}_{1} \\ {w}_{2} \\ {w}_{3} \\ {w}_{4}\end{matrix} ] , \qquad equation ( 15 )$$

where y₁ and y₂ are the signals received by the antennas 308-1 and 308-2 of the first user terminal 302, respectively, y₃ and y₄ are the signals received by the antennas 308-3 and 308-4 of the second user terminal 304, respectively, and w₁, w₂, w₃, and w₄ are noise signals.

Equation (15) may be further expressed as follows:

y₁=\tilde{h}₁₁u₁+\tilde{h}₁₂u₂+\tilde{h}₁₃u₃+\tilde{h}₁₄u₄+w₁

y₂=\tilde{h}₂₁u₁+\tilde{h}₂₂u₂+\tilde{h}₂₃u₃+\tilde{h}₂₄u₄+w₂

y₃=\tilde{h}₃₁u₁+\tilde{h}₃₂u₂+\tilde{h}₃₃u₃+\tilde{h}₃₄u₄+w₃

y₄=\tilde{h}₄₁u₁+\tilde{h}₄₂u₂+\tilde{h}₄₃u₃+\tilde{h}₄₄u₄+w₄ equations (16)

where \tilde{h}ᵢⱼ (i=1, 2, 3, and 4; j=1, 2, 3, and 4) are equivalent channel gains which, similar to the description above in connection with equations (11) and (12), the user terminals 302 and 304 may determine based on the channel responses of the communication channels. Furthermore, the first and second messages u₁ and u₂ are known to the first user terminal 302, since the first user terminal 302 transmitted the first and second messages u₁ and u₂ to the transmitting terminal 306. Therefore, the first user terminal 302 may subtract the signal component corresponding to the term \tilde{h}₁₁u₁+\tilde{h}₁₂u₂ in equations (16) from the received signal y₁, and subtract the signal component corresponding to the term \tilde{h}₂₁u₁+\tilde{h}₂₂u₂ in equations (16) from the received signal y₂. Similarly, the third and fourth messages u₃ and u₄ are known to the second user terminal 304, since the second user terminal 304 transmitted the third and fourth messages u₃ and u₄ to the transmitting terminal 306. Therefore, the second user terminal 304 may subtract the signal component corresponding to the term \tilde{h}₃₃u₃+\tilde{h}₃₄u₄ in equations (16) from the received signal y₃, and subtract the signal component corresponding to the term \tilde{h}₄₃u₃+\tilde{h}₄₄u₄ in equations (16) from the received signal y₄.

Additionally, the first user terminal 302 may operate to remove the noise signals w₁ and w₂ from the received signals y₁ and y₂, respectively, and the second user terminal 304 may operate to remove the noise signals w₃ and w₄ from the received signals y₃ and y₄, respectively. In such manner, the first user terminal 302 may decode, on a bit level or a symbol level, the received signals y₁ and y₂ to receive the third and fourth messages u₃ and u₄ from the second user terminal 304 with the equivalent channel gains \tilde{h}₁₃ and \tilde{h}₂₄ being maximized, and the second user terminal 304 may decode, on a bit level or a symbol level, the received signals y₃ and y₄ to receive the first and second messages u₁ and u₂ from the first user terminal 302 with the equivalent channel gains \tilde{h}₃₁ and \tilde{h}₄₂ being maximized.

In exemplary embodiments, a general precoding matrix P may be determined for a transmitting terminal and first and second user terminals in a MU-MIMO system, based on channel responses of communication channels between the transmitting terminal and each of the first and second user terminals. For example, if the first and second user terminals each have N_{R} antennas, and the transmitting terminal has N_{T} (N_{T}≧2*N_{R}) antennas, a channel response matrix H representing the channel responses of the communication channels may be expressed as follows:

$$H = [ \begin{matrix}{{h}^{}}_{1} \\ ⋮ \\ {{h}^{}}_{{N}_{R}} \\ {{h}^{}}_{{N}_{R} + 1} \\ ⋮ \\ {{h}^{}}_{{2}^{*} {N}_{R}}\end{matrix} ] , \qquad equation ( 17 )$$

where \vec{h}ᵢ=[hᵢ₁ hᵢ₂ . . . h_{iN}_{_{T}}] (i=1, 2, . . . , and 2*N_{R}) are each a vector representing the channel responses of the communication channels between the N_{T} antennas on the transmitting terminal side and an i^{th} one of the 2*N_{R} antennas on the user terminal side. Correspondingly, the general preceding matrix P may be determined as follows:

P=[\vec{h}_{N}_{_{R}}₊₁^{T} . . . \vec{h}_{2*N}_{_{R}}^{T} \vec{h}₁^{T} . . . \vec{h}_{N}_{_{R}}^{T}], equation (18)

where “T” denotes matrix conjugate transposition.

Accordingly, if the transmitting terminal receives messages u₁, u₂, . . . , and u_{N}_{_{R}} from the first user terminal and messages u_{N}_{_{R}}₊₁, u_{N}_{_{R}}₊₂, . . . , and u_{2*N}_{_{R}} from the second user terminal, the transmitting terminal may perform preceding on those messages to generate precoded signals and transmit, after modulation, the precoded signals to the first and second user terminals. As a result, signals received by the first and second user terminals may be calculated as follows:

$$[ \begin{matrix}{y}_{1} \\ ⋮ \\ {y}_{{N}_{R}} \\ {y}_{{N}_{R} + 1} \\ ⋮ \\ {y}_{{2}^{*} {N}_{R}}\end{matrix} ] = [ \begin{matrix}{{h}^{}}_{1} \\ ⋮ \\ {{h}^{}}_{{N}_{R}} \\ {{h}^{}}_{{N}_{R} + 1} \\ ⋮ \\ {{h}^{}}_{{2}^{*} {N}_{R}}\end{matrix} ] [ {{h}^{}}_{{N}_{R} + 1}^{T} … {{h}^{}}_{{2}^{*} {N}_{R}}^{T} {{h}^{}}_{1}^{T} … {{h}^{}}_{{N}_{R}}^{T} ] [ \begin{matrix}{u}_{1} \\ ⋮ \\ {u}_{{N}_{R}} \\ {u}_{{N}_{R} + 1} \\ ⋮ \\ {u}_{{2}^{*} {N}_{R}}\end{matrix} ] + [ \begin{matrix}{w}_{1} \\ ⋮ \\ {w}_{{N}_{R}} \\ {w}_{{N}_{R} + 1} \\ ⋮ \\ {w}_{{2}^{*} {N}_{R}}\end{matrix} ] , \qquad equation ( 19 )$$

where yᵢ(i=1, 2, . . . , and N_{R}) are the signals received by the first user terminal, and yᵢ (i=N_{R}+1, N_{R}+2, . . . , and 2*N_{R}) are the signals received by the second user terminal. The first user terminal may then decode, on a bit level or a symbol level, its received signals yᵢ(i=1, 2, . . . , and N_{R}) to receive the messages u_{N}_{_{R}}₊₁, u_{N}_{_{R}}₊₂, . . . , and u_{2*N}_{_{R}} from the second user terminal, and the second user terminal may decode, on a bit level or a symbol level, its received signals yᵢ (i=N_{R}+1, N_{R}+2, . . . , and 2*N_{R}) to receive the messages u₁, u₂, . . . , and u_{N}_{_{R}} from the first user terminal.

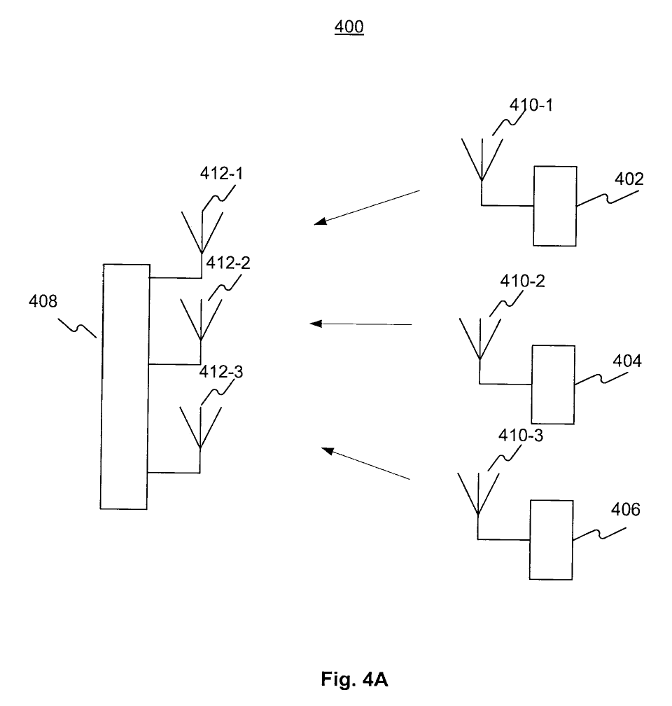

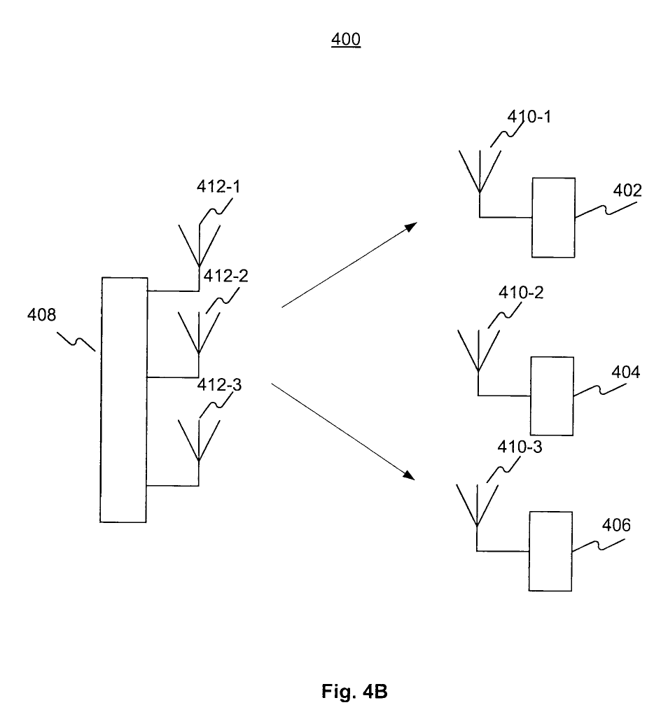

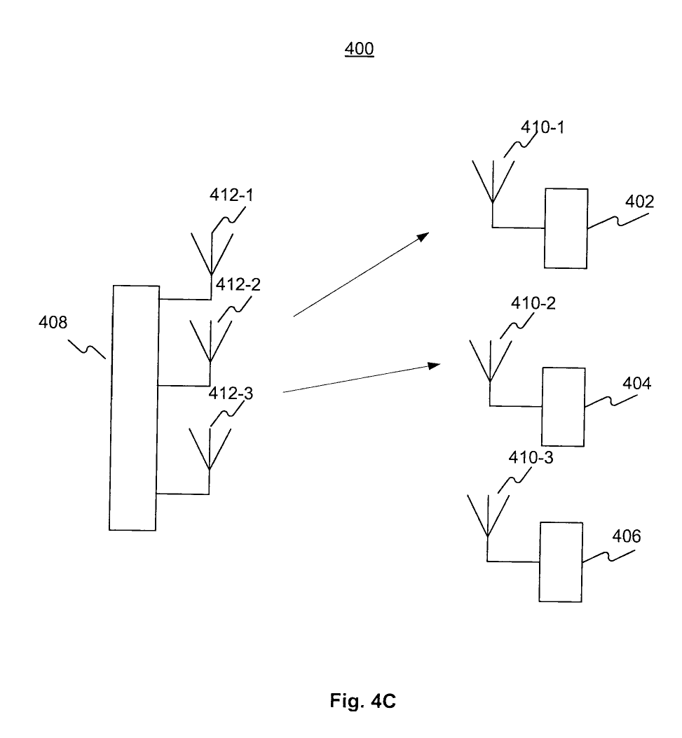

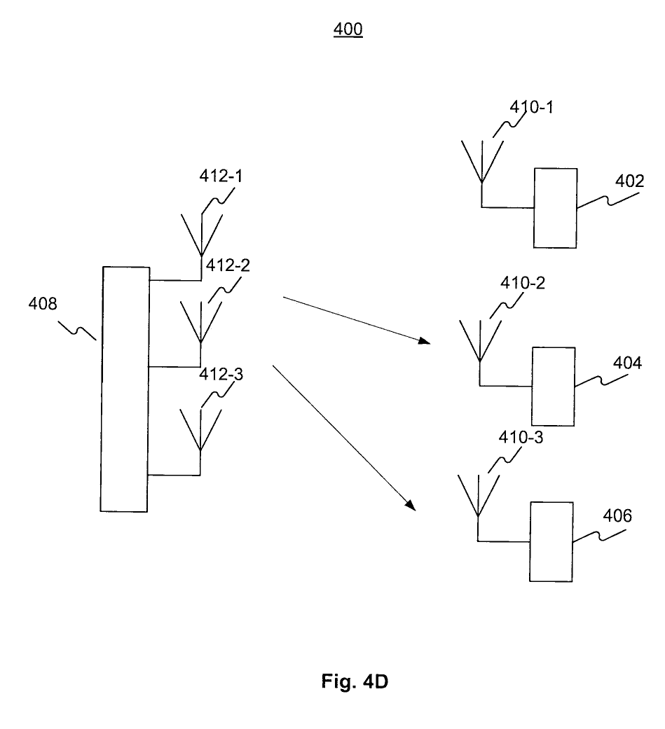

FIGS. 4A-4D illustrate a method 400 for a first user terminal 402, a second user terminal 404, and a third user terminal 406 in a MU-MIMO system to exchange data through communication with a transmitting terminal 408, according to an exemplary embodiment. For example, the user terminals 402, 404, and 406 may be any three of the user terminals 106-1, 106-2, . . . , and 106-N (FIG. 1), and the transmitting terminal 408 may be the transmitting terminal 102 (FIG. 1). Also for example, the data to be exchanged may be a first message u₁ from the first user terminal 402, a second message u₂ from the second user terminal 404, and a third message u₃ from the third user terminal 406. For illustrative purposes only, it is assumed that the first user terminal 402 includes an antenna 410-1, the second user terminal 404 includes an antenna 410-2, and the third user terminal 406 includes an antenna 410-3. It is also assumed that the transmitting terminal 408 includes a first antenna 412-1, a second antenna 412-2, and a third antenna 412-3.

Referring to FIG. 4A, during a first time slot T₁, the first, second, and third user terminals 402, 404, and 406 transmit the first, second, and third messages u₁, u₂, and u₃, respectively, to the transmitting terminal 408, as represented by the arrows in FIG. 4A. As a result, the transmitting terminal 408 receives the messages u₁, u₂, and u₃ during the first time slot T₁.

Referring to FIG. 4B, during a second time slot T₂ following the first time slot T₁, the transmitting terminal 408 selects two of the three user terminals 402, 404, and 406 that have a relatively high transmit priority, e.g., the first user terminal 402 and the third user terminal 406. The transmitting terminal 408 further performs preceding on the messages u₁ and u₃ received from the selected user terminals 402 and 406 to generate precoded signals, and transmits, after modulation, the precoded signals to the user terminals 402 and 406, as represented by the arrows in FIG. 4B. As a result, the first and third user terminals 402 and 406 exchange data with each other.

Referring to FIG. 4C, during a third time slot T₃ following the second time slot T₂, the transmitting terminal 408 selects two of the three user terminals 402, 404, and 406, different than the two user terminals selected in the second time slot T₂, e.g., the first user terminal 402 and the second user terminal 404. The transmitting terminal 408 further performs preceding on the messages u₁ and u₂ received from the selected user terminals 402 and 404 to generate precoded signals, and transmits, after modulation, the precoded signals to the selected user terminals 402 and 404, as represented by the arrows in FIG. 4C. As a result, the first and second user terminals 402 and 404 exchange data with each other.

Referring to FIG. 4D, during a fourth time slot T₄ following the third time slot T₃, the transmitting terminal 408 selects two of the three user terminals 402, 404, and 406, different than the two user terminals selected in each of the second time slot T₂ and the third time slot T₃, e.g., the second user terminal 404 and the third user terminal 406. The transmitting terminal 408 further performs preceding on the messages u₂ and u₃ received from the selected user terminals 404 and 406, respectively, to generate precoded signals, and transmits, after modulation, the precoded signals to the selected user terminals 404 and 406, as represented by the arrows in FIG. 4D. As a result, the second and third user terminals 404 and 406 exchange data with each other.

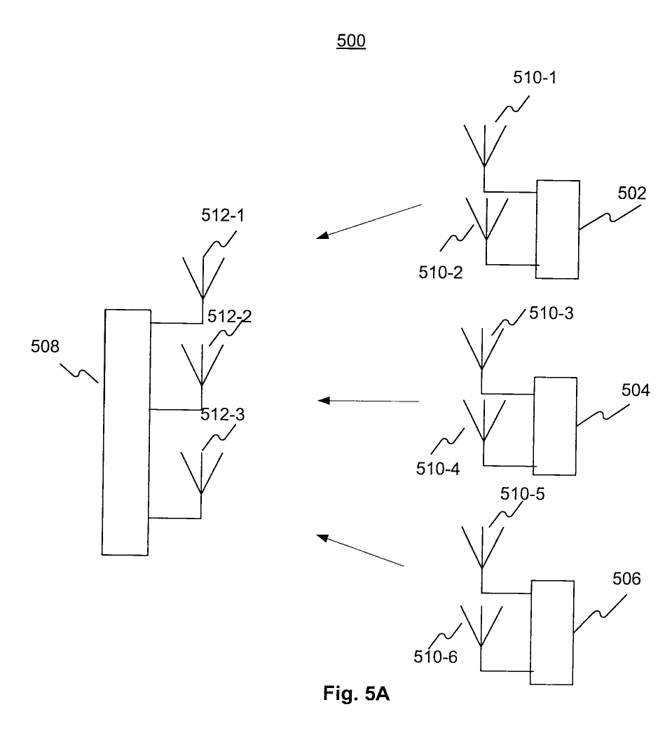

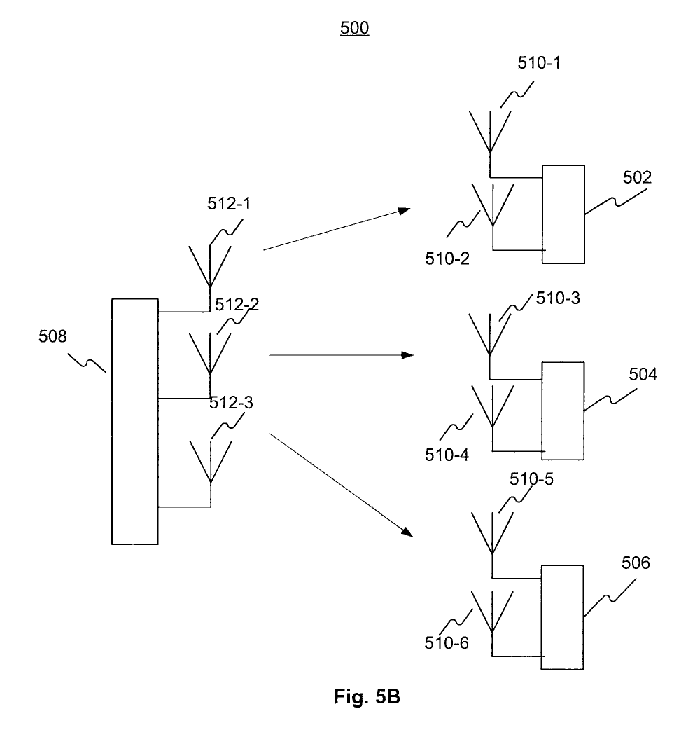

FIGS. 5A and 5B illustrate a method 500 for a first user terminal 502, a second user terminal 504, and a third user terminal 506 in a MU-MIMO system to exchange data through communication with a transmitting terminal 508, according to an exemplary embodiment. For example, the user terminals 502, 504, and 506 may be any three of the user terminals 106-1, 106-2, . . . , and 106-N (FIG. 1), and the transmitting terminal 508 may be the transmitting terminal 102 (FIG. 1). Also for example, the data to be exchanged may be a first message u₁ from the first user terminal 502, a second message u₂ from the second user terminal 504, and a third message u₃ from the third user terminal 506. For illustrative purposes only, it is assumed that the first user terminal 502 includes a first antenna 510-1 and a second antenna 510-2, the second user terminal 504 includes a first antenna 510-3 and a second antenna 510-4, and the third user terminal 506 includes a first antenna 510-5 and a second antenna 510-6. It is also assumed that the transmitting terminal 508 includes a first antenna 512-1, a second antenna 512-2, and a third antenna 512-3.

Referring to FIG. 5A, during a first time slot T₁, the first, second, and third user terminals 502, 504, and 506 transmit the first, second, and third messages u₁, u₂, and u₃, respectively, to the transmitting terminal 508, as represented by the arrows in FIG. 5A. As a result, the transmitting terminal 508 receives the messages u₁, u₂, and u₃ during the first time slot T₁.

Referring to FIG. 5B, during a second time slot T₂ following the first time slot T₁, the transmitting terminal 508 performs preceding on the messages u₁, u₂, and u₃ to generate precoded signals, and transmits, after modulation, the precoded signals to the first, second, and third user terminals 502, 504, and 506, as represented by the arrows in FIG. 5B. For example, the transmitting terminal 508 may determine a precoding matrix based on channel responses of communication channels between the transmitting terminal 508 and each of the first, second, and third user terminals 502, 504, and 506, similar to the above description. As a result, each of the user terminals 502, 504, and 506 may receive the precoded signals and decode, on a bit level or a symbol level, the received signals to receive the messages from the other user terminals. For example, the first user terminal 502 may decode its received signals to receive the messages u₂ and u₃ from the second and third user terminals 504 and 506, respectively, based on the message u₁ that is known to the first user terminal 502. As a result of the exchange, the first user terminal 502 receives the second and third messages u₂ and u₃, the second user terminal 504 receives the first and third messages u₁ and u₃, and the third user terminal 506 receives the first and second messages u₁ and u₂.

While embodiments have been described based on two or three user terminals, the invention is not so limited. It may be practiced with equal effectiveness with an arbitrary number of user terminals. Each transmitting terminal and each user terminal may have an arbitrary number of antennas.

In exemplary embodiments, different transmitting terminals, e.g., base stations, relay stations, etc., may cooperate to serve user terminals, such that the user terminals may exchange data through communication with one or more of the different transmitting terminals. For example, a relay station may be located close to a boundary of a coverage area of a base station, and may relay communication between the base station and a user terminal.

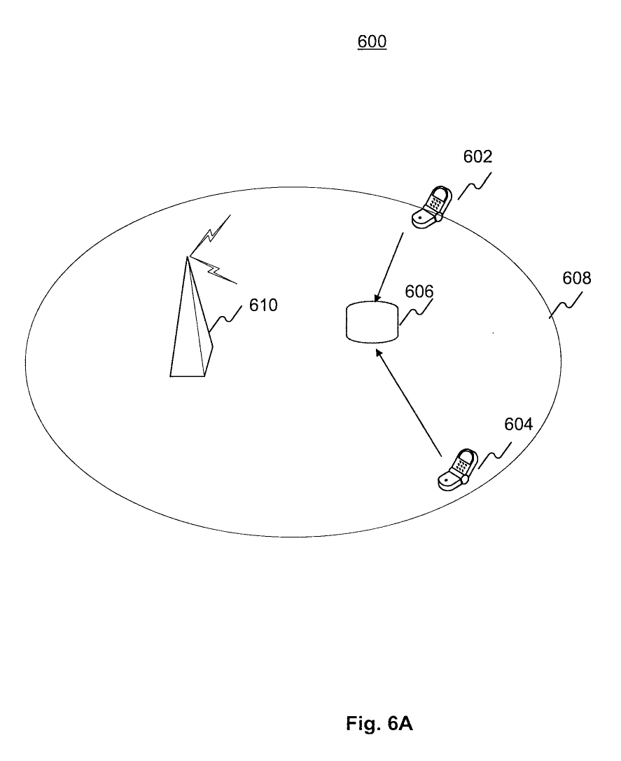

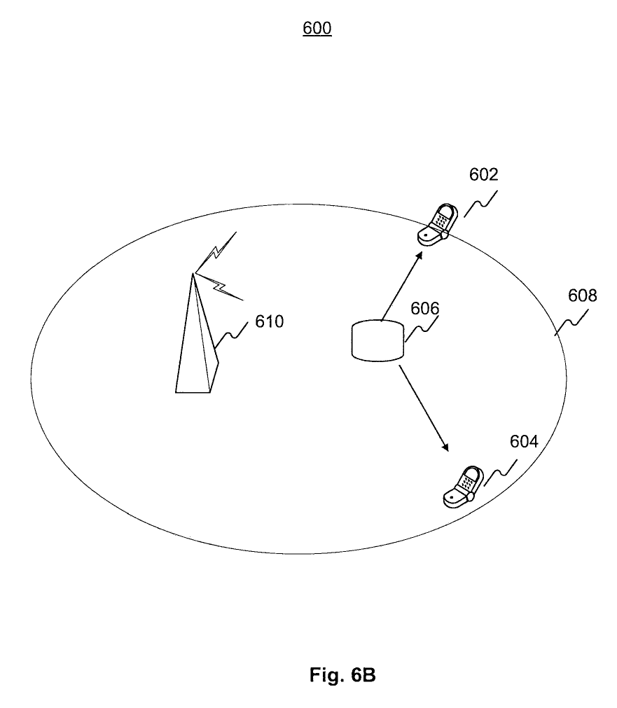

FIGS. 6A and 6B illustrate a method 600 for first and second user terminals 602 and 604 in a MU-MIMO system to exchange data through communication with a relay station 606, according to an exemplary embodiment. The first and second user terminals 602 and 604 and the relay station 606 are located in a coverage area 608 of a base station 610.

Referring to FIG. 6A, during a first time slot T₁, the first and second user terminals 602 and 604 transmit first and second messages u₁ and u₂, respectively, to the relay station 606, as represented by the arrows in FIG. 6A. As a result, the relay station 606 receives the messages u₁ and u₂ during the first time slot T₁.

Referring to FIG. 6B, during a second time slot T₂ following the first time slot T₁, the relay station 606 performs preceding on the messages u₁ and u₂ to generate precoded signals, and transmits, after modulation, the precoded signals to the first and second user terminals 602 and 604, as represented by the arrows in FIG. 6B. For example, the relay station 606 may determine a preceding matrix based on channel responses of communication channels between the relay station 606 and each of the first and second user terminals 602 and 604, as described above. As a result, each of the user terminals 602 and 604 may receive the precoded signals and decode the received signals to receive the message from the other user terminal. For example, the first user terminal 602 may decode its received signals to receive the second message u₂ from the second user terminal 604, based on the first message u₁ that is known to the first user terminal 602. Because the user terminals 602 and 604 exchange data without communicating with the base station 610, transmission overhead of the base station 610 may be reduced.

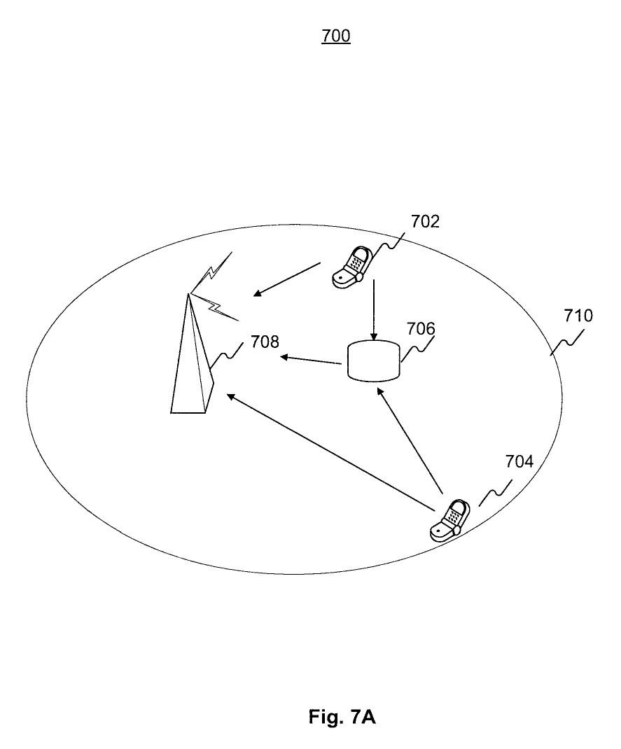

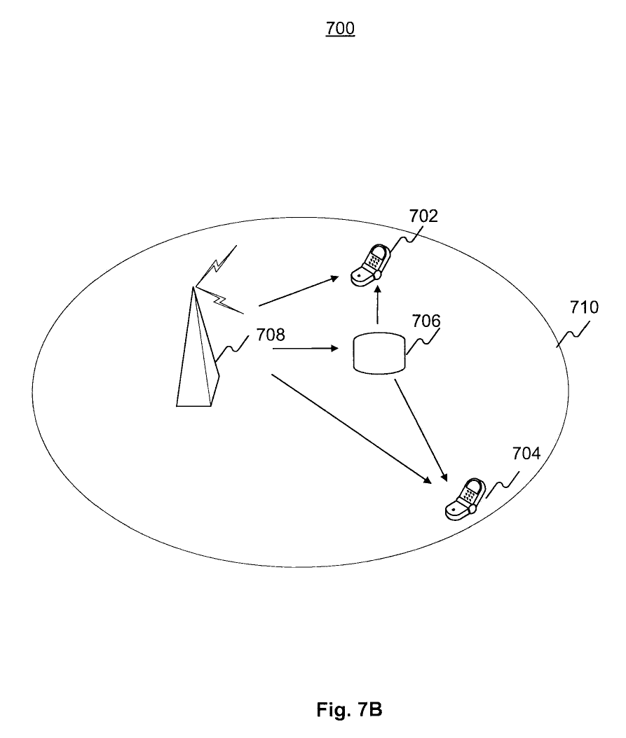

FIGS. 7A and 7B illustrate a method 700 for a first user terminal 702 and a second user terminal 704 in a MU-MIMO system to exchange data through communication with a relay station 706 and a base station 708, according to an exemplary embodiment. The first and second user terminals 702 and 704 and the relay station 706 are located in a coverage area 710 of the base station 708. For example, the first user terminal 702 is relatively close to the base station 708 and, therefore, has a relatively strong connection with the base station 708, and the second user terminal 704 is located at a boundary of the coverage area 710 and, therefore, has a relatively weak connection with the base station 708. The base station 708 and the relay station 706 may cooperatively transmit signals to the first and second user terminal 702 and 704.

Referring to FIG. 7A, during a first time slot T₁, the first user terminal 702 transmits a first message u₁ to the base station 708 and the relay station 706, and the second user terminal 704 transmits a second message u₂ to the base station 708 and the relay station 706. The relay station 706 may forward a copy of the messages u₁ and/or u₂ to the base station 708.

Referring to FIG. 7B, during a second time slot T₂ following the first time slot T₁, the base station 708 and the relay station 706 may perform preceding on their respective received messages. For example, the base station 708 may perform preceding on the messages u₁ and u₂ based on a first precoding matrix P₁, which is determined based on channel responses of communication channels between the base station 708 and the first and second user terminals 702 and 704, to generate precoded signals, and transmit the precoded signals to the first and second user terminals 702 and 704. Also for example, the relay station 706 may perform precoding on the messages u₁ and u₂ based on a second preceding matrix P₂, which is determined based on channel responses of communication channels between the relay station 706 and the first and second user terminals 702 and 704, to generate precoded signals, and transmit the precoded signals to the first and second user terminals 702 and 704. As a result, the first user terminal 702 may decode signals received from the base station 708 and the relay station 706 to receive the second message u₂ from the second user terminal 704, based on the first message u₁ that is known to the first user terminal 702, and the second user terminal 704 may also decode signals received from the base station 708 and the relay station 706 to receive the first message u₁ from the first user terminal 702, based on the second message u₂ that is known to the second user terminal 704.

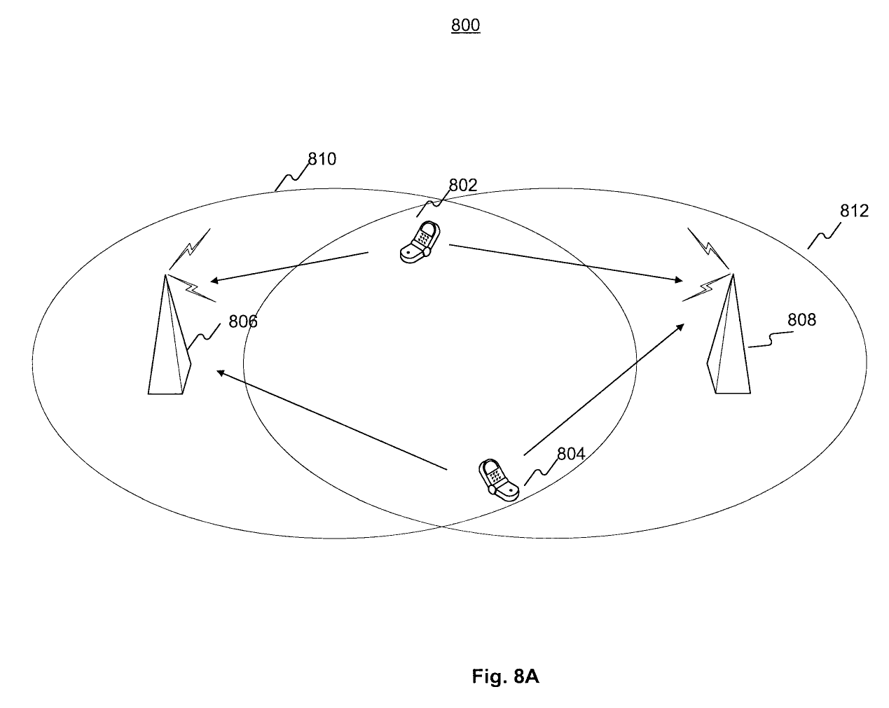

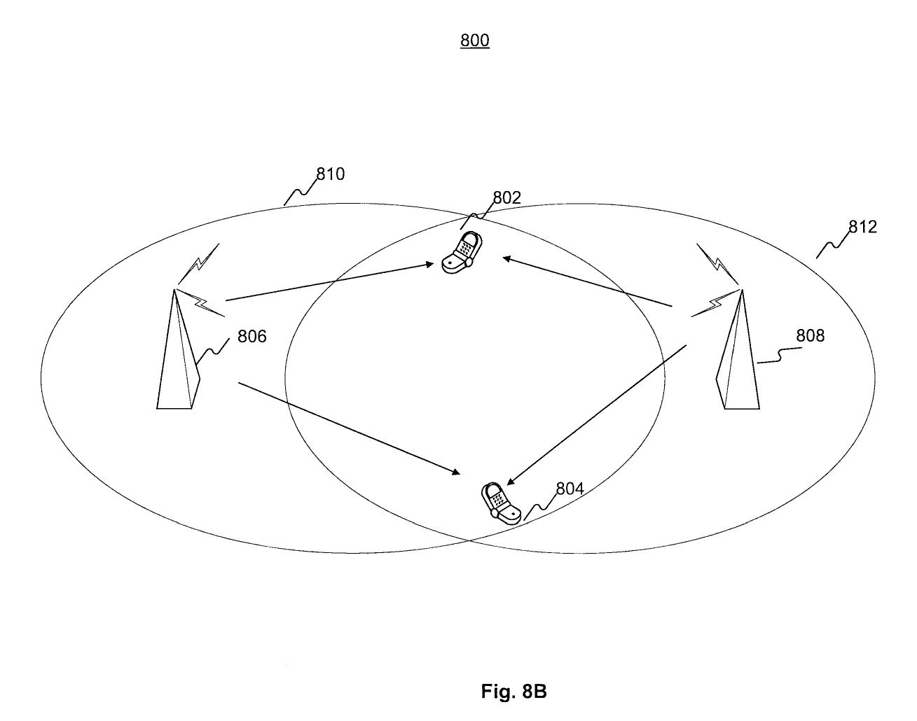

FIGS. 8A and 8B illustrate a method 800 for first and second user terminals 802 and 804 in a MU-MIMO system to exchange data through communication with first and second base stations 806 and 808, according to an exemplary embodiment. The first and second base stations 806 and 808 have first and second coverage areas 810 and 812, respectively. Each of the first and second user terminals 802 and 804 is located in a cell boundary, e.g., an overlapping area of the first and second coverage areas 810 and 812 and, therefore, may communicate with both the first and second base stations 806 and 808. In addition, the first and second base stations 806 and 808 are connected through a backhaul network (not shown).

Referring to FIG. 8A, during a first time slot T₁, the first user terminal 802 transmits a first message u₁ and channel responses of communication channels between the first base station 806 and the first user terminal 802 to the first base station 806, and also transmits the first message u₁ and channel responses of communication channels between the second base station 808 and the first user terminal 802 to the second base station 808. Similarly, the second user terminal 804 transmits a second message u₂ and channel responses of communication channels between the first base station 806 and the second user terminal 804 to the first base station 806, and also transmits the second message u₂ and channel responses of communication channels between the second base station 808 and the second user terminal 804 to the second base station 808. As a result, each of the first base station 806 and the second base station 808 receives the first message u₁ and the second message u₂.

Referring to FIG. 8B, during a second time slot T₂ following the first time slot T₁, the first and second base stations 806 and 808 may perform preceding on the messages u₁ and u₂. For example, the first base station 806 may perform preceding on the messages u₁ and u₂ based on a first precoding matrix P₁, which is determined based on the channel responses of the communication channels between the first base station 806 and the first user terminal 802 and the channel responses of the communication channels between the first base station 806 and the second user terminal 804, to generate precoded signals, and transmit, after modulation, the precoded signals to the first and second user terminals 802 and 804. Also for example, the second base station 808 may perform precoding on the messages u₁ and u₂ based on a second precoding matrix P₂, which is determined based on the channel responses of the communication channels between the second base station 808 and the first user terminal 802 and the channel responses of the communication channels between the second base station 808 and the second user terminal 804, to generate precoded signals, and transmit, after modulation, the precoded signals to the first and second user terminals 802 and 804. As a result, the first user terminal 802 may decode signals received from the first and second base stations 806 and 808 to receive the second message u₂ from the second user terminal 804, based on the first message u₁ that is known to the first user terminal 802, and the second user terminal 804 may also decode signals received from the first and second base stations 806 and 808 to receive the first message u₁ from the first user terminal 802, based on the second message u₂ that is known to the second user terminal 804.

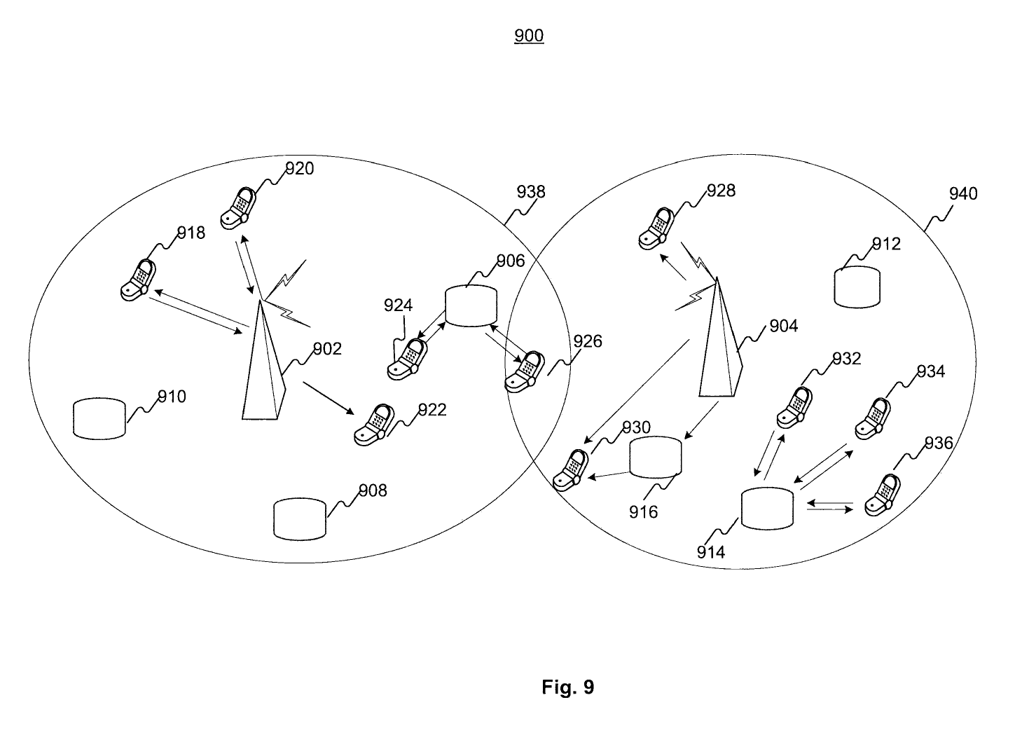

FIG. 9 illustrates a MU-MIMO system 900, according to an exemplary embodiment. The system 900 includes first and second base stations 902 and 904, a plurality of relay stations 906, 908, . . . , and 916, and a plurality of user terminals 918, 920, . . . , and 936. The first and second base stations 902 and 904 have first and second coverage areas 938 and 940, respectively. Locations of the relay stations and the user terminals are shown in FIG. 9.

In one exemplary embodiment, the user terminals 918 and 920 exchange data through communication with the base station 902; the user terminals 924 and 926 exchange data through communication with the relay station 906; the user terminals 932, 934, and 936 exchange data through communication with the relay station 914; the base station 902 transmits data to the user terminal 922; the base station 904 transmits data to the user terminal 928; and the base station 904 and the relay station 916 cooperate to transmit data to the user terminal 930. The base stations 902 and 904 and the relay stations 906, 908, . . . , and 916 are configured to perform the above-described precoding methods, and the user terminals 918, 920, . . . , and 936 are configured to perform the above-described decoding methods.

In exemplary embodiments, the above-described preceding methods may be used in a MU-MIMO system that performs signal modulation based on an orthogonal frequency-division multiplexing (OFDM) technique. For example, after a transmitting terminal performs preceding to generate precoded signals, the transmitting terminal may further perform, based on the OFDM technique, modulation on the precoded signals to generate OFDM signals.

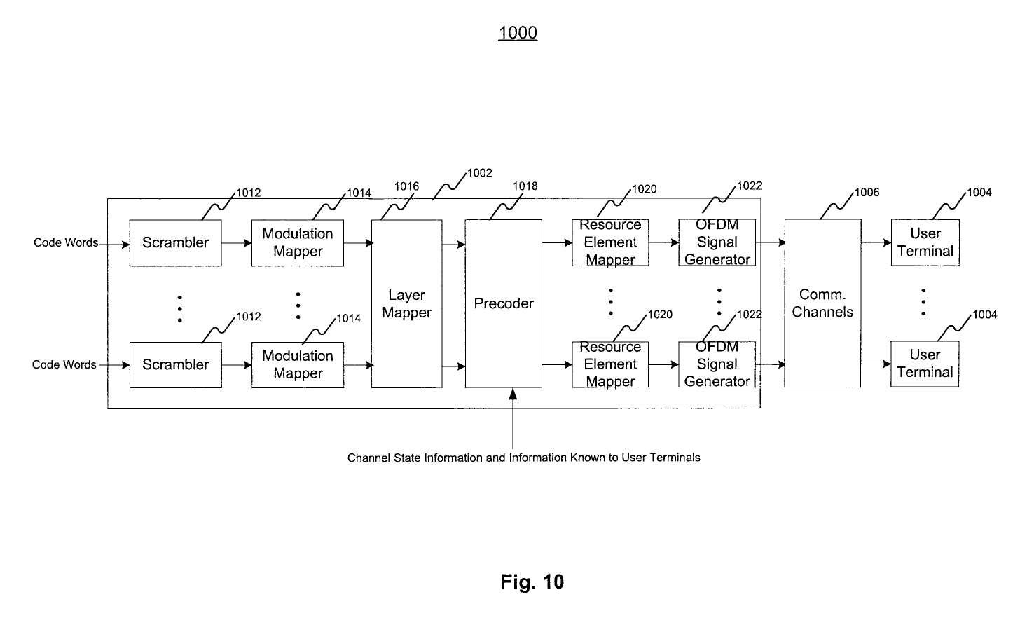

FIG. 10 illustrates a method 1000 for a transmitting terminal 1002 to generate precoded signals and modulate the precoded signals based on the OFDM technique, according to an exemplary embodiment. For example, the transmitting terminal 1002 communicates with a plurality of user terminals 1004 through communication channels 1006. The transmitting terminal 1002 is configured to perform preceding based on channel state information, such as channel responses of the communication channels 1006, and on bit-level or symbol-level information known to the user terminals 1004, e.g., messages to be exchanged by the user terminals 1004. For example, the user terminals 1004 provide the channel state information and the known information to the transmitting terminal 1002.

Referring to FIG. 10, the transmitting terminal 1002 includes scramblers 1012, modulation mappers 1014, a layer mapper 1016, a precoder 1018, resource element mappers 1020, and OFDM signal generators 1022.

In exemplary embodiments, code words representing data to be transmitted are scrambled by the scrambler 1012, and further modulated by the modulation mapper 1014 to generate complex-valued modulation symbols. The complex-valued modulation symbols are mapped onto one or more transmission layers by the layer mapper 1016. Precoding is then performed on the complex-valued modulation symbols on the one or more transmission layers by the precoder 1018, to generate precoded symbols. The precoded symbols are further mapped to resource elements by the resource element mappers 1020, for generating time-domain OFDM signals by the OFDM signal generators 1022.

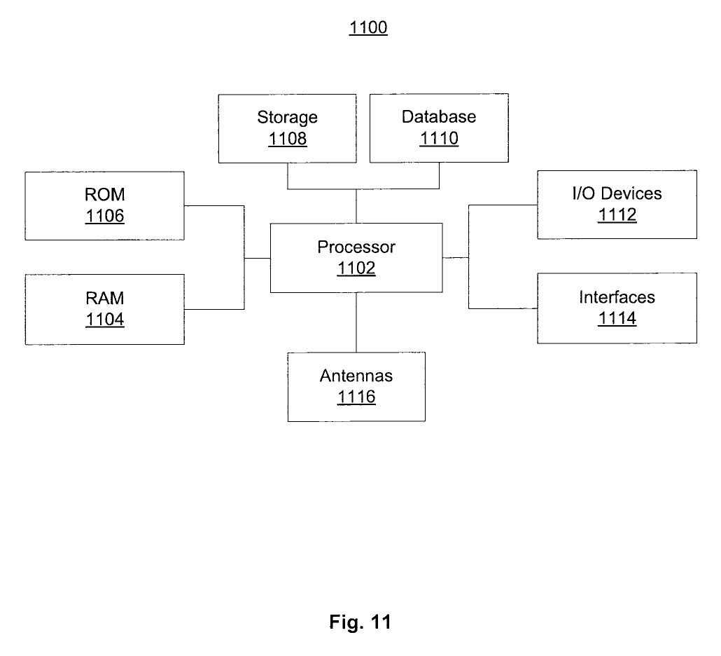

FIG. 11 illustrates a block diagram of a transmitting terminal 1100, according to an exemplary embodiment. For example, the transmitting terminal 1100 may be any of the above-described transmitting terminals, such as the above-described base stations or relay stations. Referring to FIG. 11, the transmitting terminal 1100 may include one or more of the following components: a processor 1102 configured to execute computer program instructions to perform various processes and methods, random access memory (RAM) 1104 and read only memory (ROM) 1106 configured to access and store information and computer program instructions, storage 1108 to store data and information, databases 1110 to store tables, lists, or other data structures, I/O devices 1112, interfaces 1114, antennas 1116, etc. Each of these components is well-known in the art and will not be discussed further.

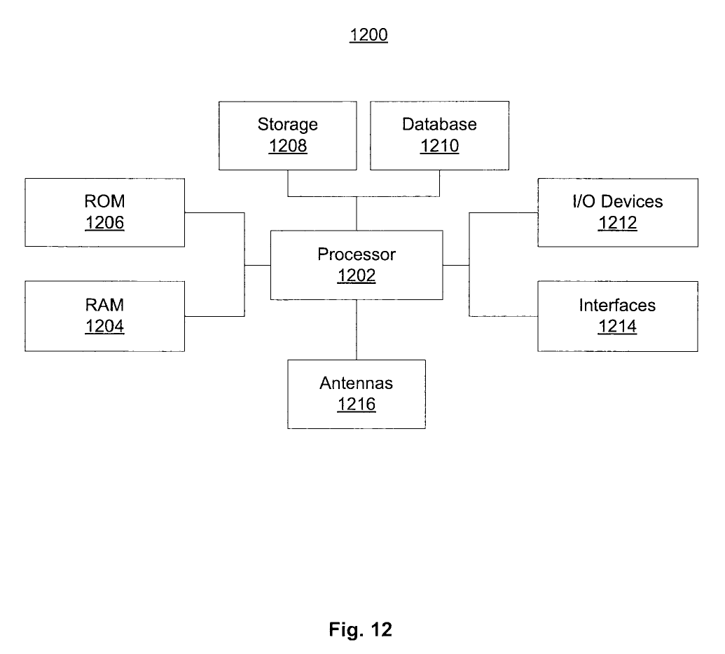

FIG. 12 illustrates a block diagram of a user terminal 1200, according to an exemplary embodiment. For example, the user terminal 1200 may be any of the above-described user terminals. Referring to FIG. 12, the user terminal 1200 may include one or more of the following components: a processor 1202 configured to execute computer program instructions to perform various processes and methods, random access memory (RAM) 1204 and read only memory (ROM) 1206 configured to access and store information and computer program instructions, storage 1208 to store data and information, databases 1210 to store tables, lists, or other data structures, I/O devices 1212, interfaces 1214, antennas 1216, etc. Each of these components is well-known in the art and will not be discussed further.

Other embodiments of the invention will be apparent to those skilled in the art from consideration of the specification and practice of the disclosure disclosed here. The scope of the invention is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for a first user terminal to receive data from a second user terminal, wherein the first and second user terminals communicate with a transmitting terminal, the method comprising:
transmitting a first message to the transmitting terminal;
receiving a signal from the transmitting terminal, the received signal including information regarding the first message and a second message transmitted from the second user terminal to the transmitting terminal; and
decoding, based on the first message, the received signal to receive the second message.

2. The method of claim 1, further comprising:
estimating channel state information between the transmitting terminal and the first user terminal; and
providing the estimated channel state information to the transmitting terminal.

3. The method of claim 1, further comprising:
transmitting reference signals to the transmitting terminal, for the transmitting terminal to estimate channel state information between the transmitting terminal and the first user terminal.

4. The method of claim 1, wherein the decoding comprises:
subtracting from the received signal a component in the received signal corresponding to the first message.

5. The method of claim 1, wherein the decoding comprises:
decoding the received signal on a bit level or on a symbol level.

6. A first user terminal to receive data from a second user terminal, wherein the first and second user terminals communicate with a transmitting terminal, the first user terminal comprising:
at least one antenna configured to transmit a first message to the transmitting terminal and to receive a signal from the transmitting terminal, the received signal including information regarding the first message and a second message transmitted from the second user terminal to the transmitting terminal; and
a processor configured to decode, based on the first message, the received signal to receive the second message.

7. The first user terminal of claim 6, wherein the processor is further configured to:
estimate channel state information between the transmitting terminal and the first user terminal; and
provide the estimated channel state information to the transmitting terminal.

8. The first user terminal of claim 6, wherein the processor is further configured to:
transmit reference signals to the transmitting terminal, for the transmitting terminal to estimate channel state information between the transmitting terminal and the first user terminal.

9. The first user terminal of claim 6, wherein the processor is further configured to:
subtract from the received signal a component in the received signal corresponding to the first message.

10. The first user terminal of claim 6, being configured to operate in a multiple-user multiple-input and multiple-output (MU-MIMO) communication system.

11. The first user terminal of claim 6, being a mobile station or a fixed station.

12. A method for a transmitting terminal to transmit precoded signals, comprising:
receiving first and second messages from first and second user terminals, respectively, thereby to determine the first and second user terminals are exchanging data;
performing, based on the determining that the first and second user terminals are exchanging data, preceding on the first and second messages to generate precoded signals; and
transmitting the precoded signals.

13. The method of claim 12, wherein the preceding is performed based on channel state information between the transmitting terminal and the second user terminal, such that a component corresponding to the first message in a signal received by the second user terminal from the transmitting terminal may be maximized.

14. The method of claim 13, further comprising:
obtaining the channel state information from the second user terminal.

15. The method of claim 13, further comprising:
estimating the channel state information based on reference signals received from the second user terminal.

16. The method of claim 12, further comprising:
performing, before the transmitting, modulation on the precoded signals.

17. The method of claim 12, wherein the precoded signals include a set of signals resulting from the precoding, the method further comprising:
transmitting the set of precoded signals at substantially the same time.

18. A transmitting terminal, comprising:
a plurality of antennas configured to receive first and second messages from first and second user terminals, respectively;
a processor configured to perform, based on determining the first and second user terminals are exchanging data, preceding on the first and second messages to generate precoded signals; and
the plurality of antennas configured to transmit the precoded signals.

19. The transmitting terminal of claim 18, wherein the processor is configured to perform the preceding based on channel state information between the transmitting terminal and the second user terminal, such that a component corresponding to the first message in a signal received by the second user terminal from the transmitting terminal may be maximized.

20. The transmitting terminal of claim 19, wherein the processor is further configured to:
obtain the channel state information from the second user terminal, or estimate the channel state information based on reference signals received from the second user terminal.

21. The transmitting terminal of claim 18, wherein the processor is further configured to:
perform modulation on the precoded signals.

22. The transmitting terminal of claim 18, wherein the precoded signals include a set of signals resulting from the preceding, the plurality of antennas being further configured to:
transmit the set of precoded signals at substantially the same time.

23. The transmitting terminal of claim 18, being configured to operate in a multiple-user multiple-input and multiple-output (MU-MIMO) communication system.

24. The transmitting terminal of claim 18, being configured to cooperate with another transmitting terminal to transmit the first message to the second user terminal.

25. The transmitting terminal of claim 18, being a base station, a relay station, or an access point.
